(19) United States
(12) Patent Application Publication
(10) Pub. No.: US 2023/0394043 A1
(43) Pub. Date: Dec. 7, 2023

(54) SYSTEMS AND METHODS FOR OPTIMIZING QUERIES IN A DATA LAKE

(71) Applicant: MongoDB, Inc., New York, NY (US)

(72) Inventors: Charles Robert Kalmanek, JR., Short Hills, NJ (US); Benjamin Flast, Brooklyn, NY (US); David Golden, Brooklyn, NY (US); Craig Geppert Wilson, Dallas, TX (US)

(73) Assignee: MongoDB, Inc., New York, NY (US)

(21) Appl. No.: 18/328,853

(22) Filed: Jun. 5, 2023

Related U.S. Application Data
(60) Provisional application No. 63/349,379, filed on Jun. 6, 2022.

(51) Int. Cl. G06F 16/2455; G06F 16/2453; G06F 16/2457; G06F 16/22

(52) U.S. Cl. CPC G06F 16/24554; G06F 16/24542; G06F 16/2457; G06F 16/221

(57) ABSTRACT

Described herein are techniques optimizing queries on data in a data lake. The techniques involve ingesting data from multiple data lake sources, partitioning the data based on a key, and generating a partition index based on the key. The partition index can then be used to efficiently perform queries on data in the data lake.

### RELATED APPLICATIONS

This application claims the benefit under 35 U.S.C. § 119(e) to U.S. Provisional Application Ser. No. 63/349,379 entitled “SYSTEMS AND METHODS FOR OPTIMIZING QUERIES IN A DATA LAKE”, filed on Jun. 6, 2022, which is herein incorporated by reference in its entirety.

### BACKGROUND

A data lake is a cloud-based repository for data in which a large amount of data may be stored in a variety of different formats. For example, a data lake may store large amounts of structured, semi-structured, and unstructured data. In another example, a data lake may include relational data, JSON documents, XML documents, PDF files, text files, audio files, images, video files, and/or other types of files. Data may be stored in a data lake in its native format without transformation. As such, a data lake may provide flexibility in storing huge amounts (e.g., millions, billions, or trillions of files) of different types of data.

### SUMMARY

Described herein are techniques for optimizing queries in a distributed database system including a data lake. The techniques involve ingesting data from multiple data lake sources each capable of storing data in different data formats, data architectures, etc., sorting the ingested data, partitioning the ingested data into multiple data partitions based on a key, storing the data in the multiple data partitions, and generating a corresponding partition index based on the key to facilitate queries. The partition index can then be used to identify zero or more data partitions in which data targeted by a query is located to reduce the amount of data that needs to be scanned the or execution of the query. The partition index may thus be used to execute queries more efficiently.

According to some embodiments, a system for optimizing queries in a data lake storing data originating from one or more data lake sources is provided. The system comprises: memory (e.g., long-term storage and/or active memory) configured to store: data objects of different native formats originating from the one or more data lake sources; a plurality of data partitions storing data from the data objects originating from the one or more data lake sources and partitioned based on a key; and a partition index comprising entries of values of the key associated with respective data partitions of the plurality of data partitions; and a processor configured to: receive, through a communication network, from a client device, a query on target data; identify, using the partition index, at least one data partition of the plurality of data partitions in which the target data is stored; execute the query on the identified at least one data partition to obtain response data; and transmit, through the communication network, to the client device, the response data.

According to some embodiments, a method of optimizing queries in a data lake storing data from different data lake sources is provided. The method comprises using a processor to perform: storing, in memory (e.g., long term storage and/or active memory): data objects of different native formats originating from the one or more data lake sources; a plurality of data partitions storing data from the data objects and partitioned based on a key; and a partition index comprising entries of values of the key associated with respective data partitions of the plurality of data partitions; and receiving, through a communication network, from a client device, a query on target data; identifying, using the partition index, at least one data partition of the plurality of data partitions in which the target data is stored; executing the query in the identified at least one data partition to obtain response data; and transmitting, through the communication network, to the client device, the response data.

The foregoing is a non-limiting summary.

### BRIEF DESCRIPTION OF DRAWINGS

Various aspects and embodiments will be described with reference to the following figures. It should be appreciated that the figures are not necessarily drawn to scale. Items appearing in multiple figures are indicated by the same or a similar reference number in all the figures in which they appear.

FIG. 1 shows a diagram of a system including a data lake in which some embodiments of the technology described herein may be implemented.

FIG. 2A shows a diagram of another system including a data lake and a query system for performing queries on data in the data lake, according to some embodiments of the technology described herein.

FIG. 2B shows a diagram illustrating operation of the ingestion engine of FIG. 2A, according to some embodiments of the technology described herein.

FIG. 3A shows a diagram illustrating components of a query system, according to some embodiments of the technology described herein.

FIG. 3B shows a diagram illustrating components of an ingestion engine, according to some embodiments of the technology described herein.

FIG. 4 shows a flowchart of an example process for executing a query in a data lake, according to some embodiments of the technology described herein.

FIG. 5 shows an example graphical user interface (GUI) 500 for creating a data lake ingestion pipeline, according to some embodiments of the technology described herein.

FIG. 6 shows an example GUI that allows a user to specify a schedule for data ingestion, according to some embodiments of the technology described herein.

FIG. 7 shows an example GUI that indicates data ingested through the data lake ingestion pipeline, according to some embodiments of the technology described herein.

FIG. 8 shows an example GUI that allows a user to set up ingested data as a source in a virtual collection of data, according to some embodiments of the technology described herein.

FIG. 9 shows an example process of implementing a data lake query system, according to some embodiments of the technology described herein.

FIG. 10 shows a block diagram of a specially configured distributed computer system, in which some embodiments of the technology described herein can be implemented.

### DETAILED DESCRIPTION

The inventors have developed systems and methods for optimizing queries on a data lake. The systems and methods allow queries to be executed more efficiently than conventional query systems used for data lakes. A data lake may store data in one or more data stores. The data store(s) may include one or more cloud data stores. For example, a data lake may store data in an AMAZON S3 data store, a GOOGLE CLOUD data store, a MICROSOFT AZURE data store, an HTTP data store, and/or another cloud data store. In another example, the data store(s) may include a MONGODB ATLAS cluster.

A data lake may store data originating from any number of data sources. For example, the data source(s) may include one or more databases (e.g., ORACLE, SQL SERVER, and/or POSTGRES), programmatically generated data files, sensor data, log data, streaming event data, and/or other data source(s).

A data lake may store data of different native formats. Data may be stored in a data lake as-is without having to perform structuring operations on the data upfront. For example, a data lake may store data in a variety of formats such as JSON, B SON, CSV, TSV, AVRO, PARQUET, XML, ORC, PROTOCOL BUFFERS, PDF, and/or other formats. The data lake may include structured, semi-structured, and/or unstructured data.

The above-described characteristics of a data lake make it suitable for storing large amounts of data (e.g., millions, billions, or trillions of data objects) without performing any structuring of the data. For example, a data lake may be useful for long term storage, archiving, big data analytics, data science applications, machine learning, and/or other applications requiring storage of large amounts of data in different native formats. Typically, a data lake is not suitable for use by an application that requires up to date data and performs frequent queries as part of its operation, rather data lake storage is used for long term and/or low access repositories. For example, a data lake may not be suitable for storing data for a credit card transaction application that requires real time data and performs frequent queries.

Although data lakes are efficient for storing large amounts of data, data lakes are inefficient in executing queries. Execution of a query may require scanning a large amount of data in the data lake to identify data targeted by the query resulting in long query execution times. Further, as the amount of data stored in a data lake grows, query performance may further degrade as the amount of data that needs to be scanned increases. Moreover, a computer system for executing a query may be physically separated from data store(s) in which data is stored. Thus, time to execute the query may include latency for the computer system to access the data store(s) through a communication network (e.g., the Internet).

Accordingly, the inventors have developed systems and methods that improve performance of query execution in a data lake. The system ingests data from various data lake sources and partition the data into multiple data partitions. A data partition may be a storage unit for storage of data. In some embodiments, a data partition may be a data file. The data file may include one or more data objects. For example, a data file may include documents. The system partitions the data into the multiple data partitions by: (1) determining a key based on patterns of queries expected to be executed on the data; and (2) portioning the data into the multiple data partitions based on the key. The system generates a partition index in which the partitions are organized and indexed by the key. The partition index may also be referred to herein as a “catalog”. The system may use the partition index to identify one or more data partitions in which data targeted by a query is located, and then execute the query on the identified data partition(s). The partition index thus allows the system to reduce the amount of data that needs to be scanned to execute a query, and thus allows queries on data in a data lake to be executed more efficiently.

Some embodiments provide a system for optimizing queries on data in a data lake storing data from one or more data lake sources. The system may be configured to store data ingested from the data lake source(s) in multiple data partitions that are partitioned based on a key. The system may be configured to store a partition index comprising entries of values of the key associated with respective data partitions. The system may be configured to execute a query (e.g., a MONGODB Query Language (MQL) query, an SQL query, or other type of query) by using the partition index to identify a data partition in which data targeted by the query is stored, and then executing the query on the identified data partition. The system may reduce the amount of data in the updated data lake that needs to be scanned in order to execute a query and thus allows queries to be executed more efficiently.

In some embodiments, the system may provide an analytic storage service for data extracted from ingested data and stored in the multiple data partitions. The system may provide low latency query performance. In some embodiments, the system may be optimized for flat data or nested data.

In some embodiments, the data partitions may be stored in shards that are associated with respective ranges of a shard key. The key used to partition the data into the data partitions may be the shard key. In some embodiments, the shard key may be indicated by user input. For example, the system may receive configuration information indicating one or more fields to use as the shard key and/or the key for partitioning the data. The system may be configured to balance the data partitions among the shards. In some embodiments, the system may be configured to perform rebalancing to maintain a target distribution (e.g., an approximately uniform distribution) of data partitions among the shards.

In some embodiments, the system may be configured to determine metadata about data in the data lake and store the determined metadata in the partition index. For example, the metadata may include statistical information about the data (e.g., counts, means, medians, variance, and/or other parameters). The system may be configured to respond to queries requesting metadata by accessing the metadata from the partition index instead of scanning for the data and then calculating the metadata. The system may thus respond to queries requesting metadata more efficiently by eliminating computation associated with scanning, accessing, and calculating the metadata.

The techniques described herein may be implemented in any of numerous ways, as the techniques are not limited to any particular manner of implementation. Examples of details of implementation are provided herein solely for illustrative purposes. Furthermore, the techniques disclosed herein may be used individually or in any suitable combination, as aspects of the technology described herein are not limited to the use of any particular technique or combination of techniques.

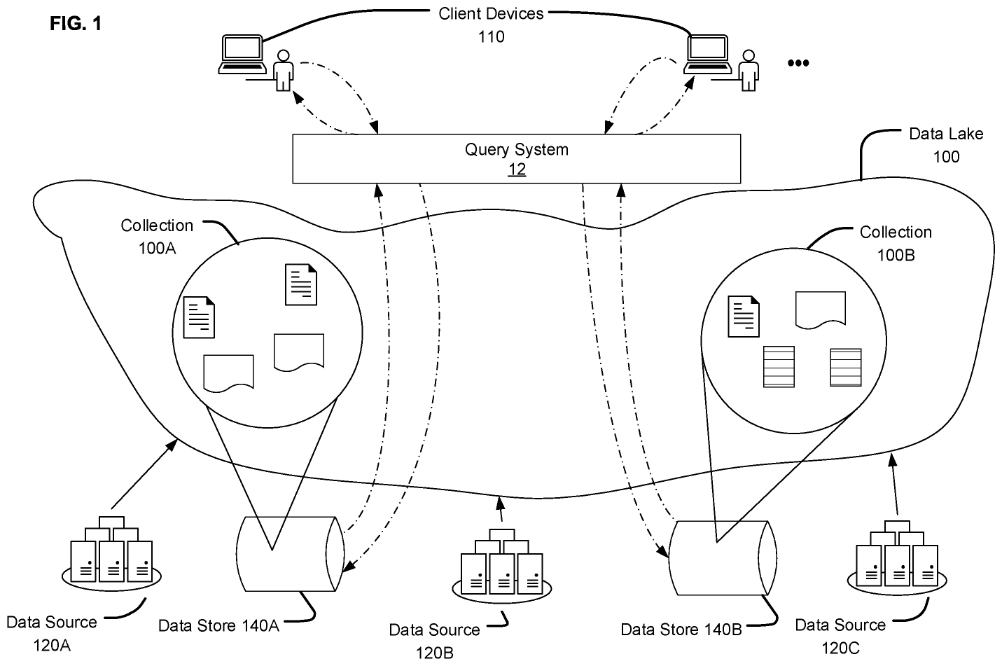

FIG. 1 shows a diagram of a system including a data lake 100 in which some embodiments of the technology described herein may be implemented. The system of FIG. 1 includes the data lake 100, a query system 12, client devices 110, data sources 120A, 120B, 120C, and data stores 140A, 140B.

As shown in FIG. 1, the data lake 100 receives data from data sources 120A, 120B, 120C. A data lake may store data originating from any number of data sources. For example, a data source may be another database (e.g., ORACLE, SQL SERVER, and/or POSTGREST), a software application that generates files, a sensor, a log, a stream of event data, and/or another data source.

In some embodiments, the data objects may have different native formats. Example native formats are described herein. The data objects may include data objects that are structured, semi-structured, and/or unstructured. As an illustrative example, the data lake 100 may store historical data for a company for use in performing historical and/or predictive analytics. As another example, the data lake 100 may store image data for use in training a machine learning model (e.g., neural network) to perform image processing such as object identification, image segmentation, image enhancement, or other type of processing. As another example, the data lake 100 may be an archive for long term storage of data for one or more software applications.

As shown in FIG. 1, the data objects of the data lake 100 organized into virtual collections 100A, 100B. In some embodiments, the data lake 100 may be configured to organize the data objects into the virtual collections 100A, 100B. For example, the data lake 100 may be configured based on user provided configuration information (e.g., a file and/or input received through a graphical user interface (GUI)). In some embodiments, the virtual collections 100A, 100B may be associated with respective data stores. As shown in FIG. 1, the collections 100A, 100B are associated with respective data stores 140A, 140B. In some embodiments, each of the data stores 140A, 140B may be a respective cloud data store. Example cloud data stores are described herein. For example, data store 140A may be an AMAZON S3 bucket, and datastore 140B may be a MONGODB ATLAS cluster. Although the example of FIG. 1 shows that the data lake 100 has two collections, in some embodiments, the data lake 100 may be configurable to include any number of virtual collections.

In some embodiments, each of the data stores 140A, 140B may include systems that manage the data. A system for managing the data may also be referred to herein as a “storage management system”. For example, each of the data stores 140A, 140B may have a respective storage layer that manages data of the data store. The system of each data store may be configured to execute queries on data stored in the data store. For example, a storage layer may receive a query targeting data of the data store, and execute the query.

In some embodiments, each of the data stores 140A, 140B may use one or more schemas for organizing data of the data source. The schema(s) may be defined by users and used for execution of queries. A query may specify configuration parameters specific to a schema used by a data store for use by a storage layer to execute a query. For example, a query may specify a file path in which a storage layer is to execute a query to read and/or update data.

The query system 12 may be configured to respond to queries submitted by client devices (e.g., client devices 110). The query system 12 may be configured to communicate with client devices to receive queries and transmit response data obtained from execution of queries. In some embodiments, the query system 12 may be configured to communicate with the client devices through a communication network. For example, the query system 12 may communicate with the client devices through the Internet, local area network (LAN), wide area network (WAN), or other suitable communication network.

In some embodiments, the query system 12 may be a federated query system. As illustrated in FIG. 1, the query system 12 receives queries from the client devices 110. The query system 12 may be configured to: (1) determine a data store that a virtual collection that data targeted by the query belongs to; (2) and transmit the query to a data store associated with the data store. For example, the query system 12 may transmit the query to a storage management system of the data store. In the example of FIG. 1, the query system 12 transmits queries on data of collection 100A to data store 140A, and the query system 12 transmits queries on data of collection 100C to data store 140B. The query system 12 may receive response data (e.g., read data, updated data, a data update confirmation, and/or other data) obtained from execution of the query, and transmit the response data obtained from to a client device that submitted the query.

As the query system 12 of FIG. 1 transmits a query from a client device to a data store associated with a virtual collection to which data targeted by the query belongs, the user needs to have knowledge of underlying storage organization (e.g., file organization, schema, and/or other type of organization) used by the data store. For example, the user may need to specify a file path in a query submitted to the query system 12. In another example, a user may need to specify, in a query, configuration parameters specific to a user defined schema used for storing data in the data store.

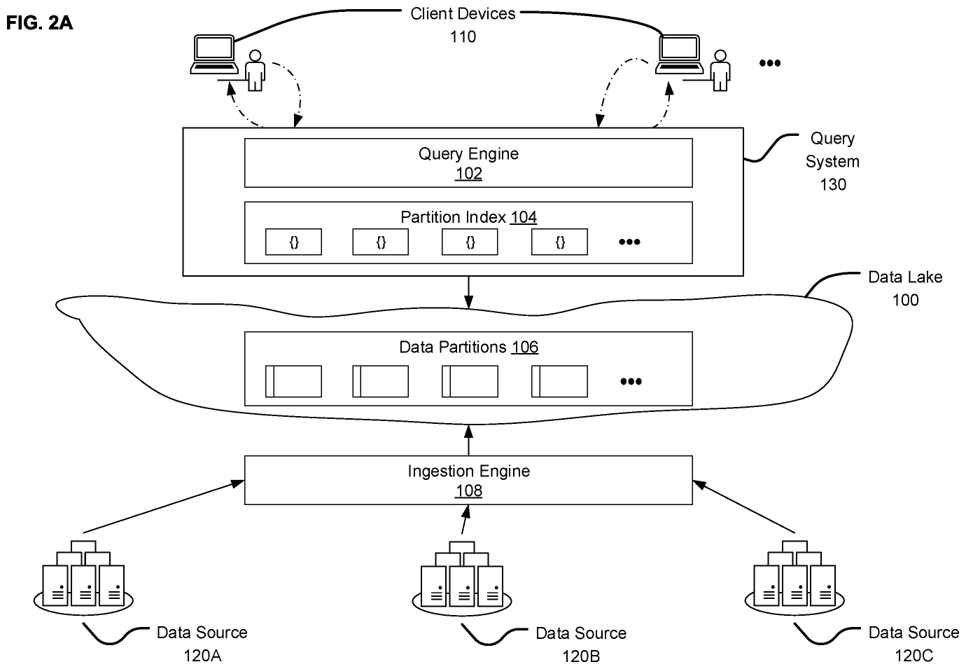

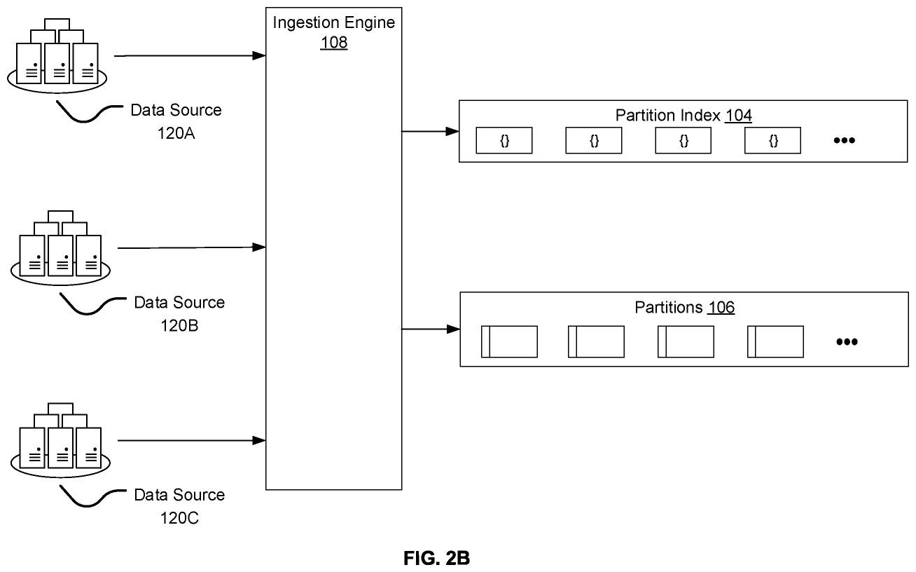

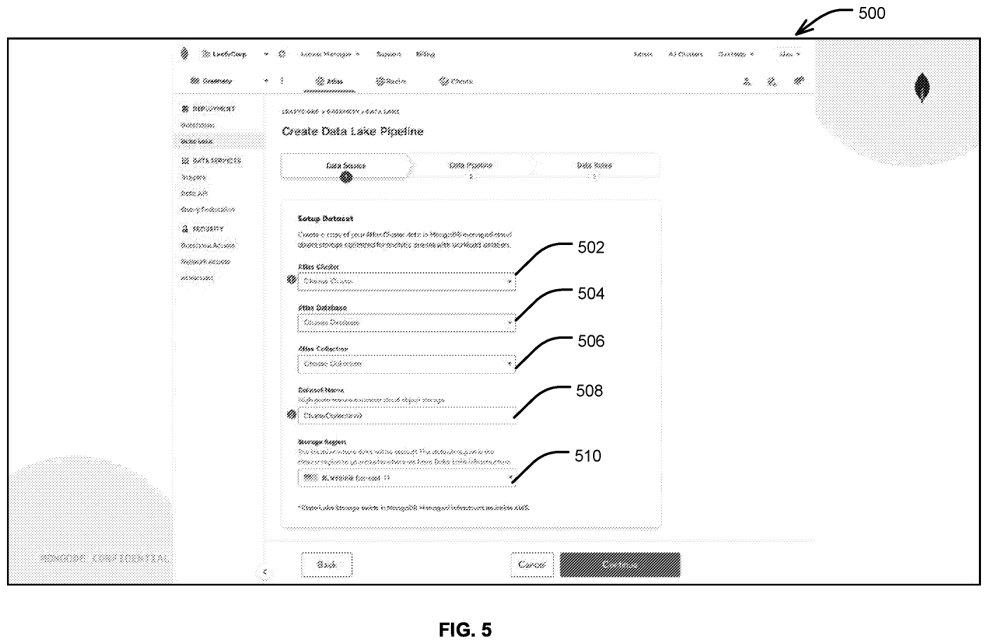

FIG. 2A shows a diagram of an ingestion engine 108 for ingesting data into the data lake 100 and a query system 130 for executing queries in the data lake 100, according to some embodiments of the technology described herein. As shown in FIG. 2A, the ingestion engine 108 ingests data from multiple sources 120A, 120B, 120C. Data in the data lake 100 is stored in data partitions 106. As shown in FIG. 2A, the query system 130 includes a query engine 102, and a partition index 104. The query system 130 and ingestion engine 108 may each be implemented using a suitable computer system. Example computer systems are described herein with reference to FIG. 5.

FIG. 2B shows a diagram illustrating operation of the ingestion engine 108, according to some embodiments of the technology described herein. As illustrated in FIG. 2B, the ingestion engine 108 may be configured to ingest data from the data lake sources 120A, 120B, 120C. For example, the ingestion engine 108 may ingest data from an AMAZON S3 cloud data store, a MONGODB ATLAS cluster, and a GOOGLE CLOUD data store. The ingestion engine 108 may be configured to ingest data by: (1) obtaining data from the data lake sources; (2) organizing the data into data partitions 106; and (3) generating a partition index 104 for the data partitions.

The ingestion engine 108 may be configured to obtain data from a data lake source in various ways. In some embodiments, the ingestion engine 108 may be configured to obtain data from a data lake source according to a schedule. For example, the ingestion engine 108 may obtain data from a data lake source every hour, every day, every week, every month, or other suitable time period. In some embodiments, the frequency of obtaining data from a data lake source may be a configurable parameter that may be adjusted by a user (e.g., administrator) of the data lake 100. In some embodiments, the ingestion engine 108 may be configured to obtain data from a data lake source based on an existing data backup schedule. For example, the ingestion engine 108 may obtain data each time a data backup is to be performed in the data backup schedule. In some embodiments, the ingestion engine 108 may be configured to obtain data from a data lake source by receiving the data through a communication network (e.g., the Internet).

In some embodiments, the ingestion engine 108 may be configured to obtain data from one or more snapshots of data stored in the data lake source. A snapshot may be a copy of data in a database at a point in time. For example, a snapshot may be a copy of all data in a cluster at a particular point in time. As another example, a snapshot may be a copy of all data in a replica set at a particular point in time. The ingestion engine 108 may be configured to ingest data from a snapshot.

The ingestion engine 108 may be configured to partition ingested data into the data partitions 106 by dividing ingested data into the partitions 106 based on a key. In some embodiments, the ingestion engine 108 may be configured to partition the data based on how the data lake 100 is expected to be queried. The ingestion engine 108 may be configured to: (1) determine a pattern of expected queries; and (2) determine the key based on the pattern of expected queries. As an illustrative example, the ingestion engine 108 may determine that data is to be queried using a date. In this example, the ingestion engine 108 may determine to use a timestamp field of the data as a key. In another example, the ingestion engine 108 may determine that data is to be queried using a numerical identifier. In this example, the ingestion engine 108 may use the numerical identifier to partition the data. In some embodiments, the ingestion engine 108 may be configured to receive user provided configuration information (e.g., a configuration file) indicating one or more fields or attributes in data objects stored in the data lake 100 that are expected to be frequently queried. The ingestion engine 108 may be configured to use the indicated field(s) or attribute(s) as key(s) for partitioning the data. In some embodiments, the ingestion engine 108 may be configured to determine one or more fields or attributes of data objects in the data lake 100 that are likely to be identified in a query. For example, the ingestion engine 108 may analyze the fields of the data objects to predict one or more fields that are most likely to be queried.

In some embodiments, the ingestion engine 108 may be configured to organize the data into shards. In some embodiments, each shard may include one or more data partitions. A key used by the ingestion engine 108 may be a shard key comprising of one or more fields. In some embodiments, each shard may be associated with a respective range of values of the shard key. In some embodiments, a shard may have an inclusive lower bound shard key value and an exclusive upper bound shard key value. In some embodiments, the ingestion engine 108 may be configured to sort data partitions based on a shard key.

The ingestion engine 108 may be configured to sort ingested data objects (e.g., documents) using a shard key. The ingestion engine 108 may be configured to sort the data object by: (1) determining shard key values of the data objects; (2) identifying one or more shards to which the; and (3) storing data from the data objects in data partition(s) of the identified shard(s). For example, the ingestion engine 108 may partition data objects into one or more files that fit inside one or more respective shards.

In some embodiments, the ingestion engine 108 may be configured to rebalance shards. The ingestion engine 108 may be configured to: (1) determine whether a shard has reached a threshold size; and (2) rebalance the shard when it is determined that the data partition has reached a threshold size. In some embodiments, the ingestion engine 108 may be configured to perform rebalancing idempotently such that only one rebalancing task for a given shard is performed at a time. In such embodiments, the ingestion engine 108 may have concurrency control to safely operate on data partition(s) within the shard without locks. In some embodiments, the ingestion engine 108 may be configured to rebalance a shard by using a list of files in the shard to determine if the shard needs to be divided into smaller shards or compacted into a fewer number of files. The ingestion engine 108 may be configured to rewrite files in the list into one or more new files up to a maximum file size. The ingestion engine 108 may be configured to replace shard range boundaries for any new shards generated from performing rebalancing.

In some embodiments, the ingestion engine 108 may be configured to determine whether a data partition spans multiple shards. The ingestion engine 108 may be configured to split a data partition into multiple data partitions that reside wholly in respective ones of the multiple shards. In some embodiments, the ingestion engine 108 may be configured to detect data partitions spanning multiple shards and divide detected data partitions as part of tasks that result in changes in shard boundaries (e.g., rebalancing of shards).

In some embodiments, the ingestion engine 108 may be configured to select a storage format for different portions of data to optimize query performance. The ingestion engine 108 may be configured to determine a storage format for each portion according to how data for the portion of data is expected to be queried. For example, the ingestion engine 108 may determine to: (1) store a first portion of data in a columnar format because the ingestion engine 108 has determined that queries aggregating data from multiple different records are more likely to be executed on the first portion of data; and (2) store a second portion of data in a row oriented format because the ingestion engine 108 has determined that queries for specific records are more likely to be executed on the second portion of data. In some embodiments, the ingestion engine 108 may be configured to partition data according to information provided by a user of the data lake 100. For example, the user may provide information indicating how the data is expected to be used, and the ingestion engine 108 may determine the data partitions 106 according to the information.

In some embodiments, the ingestion engine 108 may be configured to store data in partitions to optimize queries. In some embodiments, the ingestion engine 108 may be configured to store data that is likely to be queried in partitions that are closer together (e.g., based on a key). In some embodiments, further optimization of memory storage may be achieved at least in part by selecting a particular type of storage format (e.g., columnar or row).

The ingestion engine 108 may be configured to generate information in the partition index 104 in various ways. Information in the partition index 104 may also be referred to herein as “metadata”. In some embodiments, the ingestion engine 108 may be configured to generate the partition index 106 by using values of a field in data partitions. For example, the ingestion engine 108 may associate each data partition with a particular range of values of the field. In some embodiments, the ingestion engine 108 may be configured to determine one or more values to index the partitions with based on how the data is expected to be queried. For example, the ingestion engine 108 may index the data on a particular field based on determining that the field is likely to be queried by a user of the data lake 100. In some embodiments, the ingestion engine 108 may include index information for use in performing queries. The index information may be used by the query engine 102 to identify a partition in which data targeted by a query is located. In some embodiments, the index information may include unique values of a field in each partition. In some embodiments, the index information may include a range of values of a field stored in each partition.

In some embodiments, the ingestion engine 108 may be configured to store data in addition to the index information in the metadata of the partition index 104. In some embodiments, the ingestion engine 108 may be configured to determine statistics for data stored in the data partitions and store the statistics. For example, the ingestion engine 108 may determine counts, sums, means, standard deviations, variances, and/or other statistics for data. The ingestion engine 108 may determine the statistics using field values stored in the data partitions. The additional information may be used to satisfy queries more efficiently. In some cases, the information may eliminate a need to scan any data (e.g., when the query requests information that has been determined by the ingestion engine 108 and stored in the partition index 104).

Returning again to FIG. 2A, the query system 130 includes the data partitions 106 and the partition index 104 generated by the ingestion engine 108 (as described herein with reference to FIG. 2B). In some embodiments, the data partitions 106 may be stored collections of data. For example, the data partitions 106 may be files, documents, or other stored collections of data.

The data partitions 106 may be stored in one or more data stores. In some embodiments, the data partitions 106 may be stored in one or more cloud data stores. Example cloud data stores are described herein. In some embodiments, the data partitions 106 may be distributed. For example, data of the data partitions 106 may be distributed geographically in various data centers. In some embodiments, the data partitions 106 may be stored using storage hardware such as hard drives (e.g., hard disk drives (HDDs) and/or solid state drives (SSDs)).

The data partitions 106 may be configured to store data using one or more storage formats. In some embodiments, the storage format may be a columnar storage format. For example, the columnar storage format may be APACHE PARQUET, optimized row columnar (ORC) format, or another columnar format. In some embodiments, the storage format may be a row oriented format. For example, the row oriented format may be MYSQL, POSTGRES, or another row oriented format. In some embodiments, the ingestion engine 108 may be configured to store data using a dynamic schema. For example, the ingestion engine 108 may store the data in dynamic schema documents such as B SON or JSON documents.

In some embodiments, the data partitions 106 may be configured to store data in multiple storage formats. For example, the data partitions 106 may store a portion of the data in a columnar format and another portion of the data in a row oriented format. The data partitions 106 may store different portions of data in different formats to optimize query performance on the respective portions of data. For example, the data partitions 106 may: (1) store a first portion of data in a columnar format because queries aggregating data from multiple different records are more likely to be executed on the first portion of data; and (2) store a second portion of data in a row oriented format because queries for specific records are more likely to be executed on the second portion of data.

In some embodiments, the partition index 104 may be configured to store entries corresponding to respective ones of the data partitions 106. The partition index 104 may store, for each entry, information for use in determining whether data targeted by a query is stored in a data partition corresponding to the entry. For example, the entry may store information indicating a range of key values stored in a particular data partition, or unique field values stored in a particular data partition. The query system 130 may use a key value included in a query to identify, using the partition index, data partition(s) in which data targeted by the query is located.

In some embodiments, the partition index 104 may store metadata for use in performing queries. In some embodiments, the metadata may include statistics for data stored in the data partitions 106. For example, the metadata of the partition index 104 may include counts, sums, means, standard deviations, variances, and/or other statistics for data stored in the data partitions 106. The additional information may be used by the query engine 102 to satisfy queries more efficiently. In some cases, the information may eliminate a need to scan any data (e.g., when the query requests information that has been predetermined and stored in the partition index 104).

As shown in FIG. 2A, the query engine 102 of the query system 130 communicates with client devices 110. As indicated by the arrows between the client devices 110 and the query system 130, the query engine 102 receives queries from the client devices 110 (e.g., through a communication network) and transmits response data obtained from performing the queries.

The query engine 102 may be configured to execute a query using the partition index 104 and the data partitions 106. The query engine 102 may be configured to execute a query by: (1) identifying, using the partition index 104, one or more of the data partitions 106 in which data targeted by the query is stored; and (2) executing the query on the identified data partition(s) to obtain response data. The query engine 102 may transmit the response data to a client device that submitted the query.

In some embodiments, the query engine 102 may be configured to identify a data partition in which data targeted by a query is located using the partition index 104. The query engine 102 may be configured to: (1) identify a key value indicated by the query; and (2) identify the data partition using the field value. For example, the query engine 102 may identify an entry in the partition index 102 indicating a range of key values that include the identified key value. In another example, the query engine 102 may search for the key value in the partition index 104, and determine a data partition associated with the key value in the partition index 104.

In some embodiments, the query engine 102 may be configured to access an identified data partition. The query engine 102 may be configured to execute a query on the identified data partition. For example, the query engine 102 may scan the identified data partition for data targeted by the query. The query engine 102 may read the data, update the data, perform a calculation with the data, use the data to derive new data, and/or perform another operation using the data. The query engine 102 may be configured to obtain response data obtained from executing the query. For example, the query engine 102 may obtain data that the query commands to read, a copy of updated data, and/or a confirmation of an update performed on the data record(s). The query engine 102 may be configured to transmit the response data to the client devices 110.

In some embodiments, the query system 130 may further include a federated query system (e.g., query system 12 described herein with reference to FIG. 1). For example, the query system 130 may use the federated query system for data that is not stored in the data partitions. In another example, the system may use the federated query system when commanded by a user to do so (e.g., through configuration parameter(s) of a query). In such embodiments, the query system 130 may be configured to transmit queries for execution to storage management systems of data stores (e.g., as described herein with reference to FIG. 1).

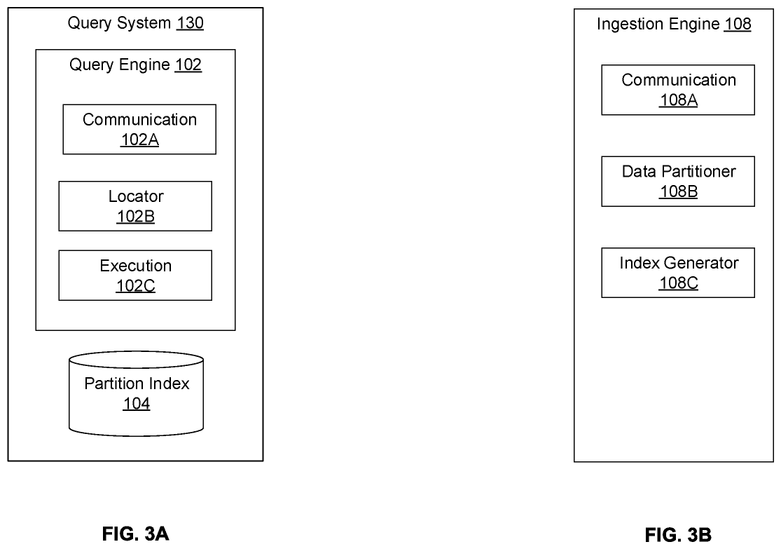

FIG. 3A shows a diagram illustrating components of the query system 130, according to some embodiments of the technology described herein. As shown in FIG. 3A, the query system 130 includes a query engine 102 and a partition index 104. The query engine 102 includes a communication module 102A, a locator module 102B, and an execution module 102C.

The communication module 102A may be configured to communicate with client devices to receive queries and transmit response data obtained from execution of the queries. In some embodiments, the communication module 102A may be configured to communicate with client devices through a communication network (e.g., the Internet). In some embodiments, the communication module 102A may be configured to communicate via an application program interface (API). In some embodiments, the communication module 102A may be configured to receive queries submitted through a graphical user interface displayed on client devices, and transmit response data for display in the graphical user interface.

The locator module 102B may be configured to locate data targeted by a query. The locator module 102B may be configured to locate data targeted by a query using the partition index 104, as described herein with reference to FIG. 2A. For example, the locator module 102B may identify one or more of the data partitions 106 storing key values indicated by the query using the partition index 104. The locator module 102B may be configured to use partition index 104 to identify the data partition(s).

The execution module 102C may be configured to execute a query on an identified data partition. The execution module 102C may be configured to read, write, update, delete, and/or perform another operation on one or more data records targeted by the query. In some embodiments, the execution module 102C may be configured to obtain response data from executing the query. For example, the execution module 102 may obtain a confirmation message or read data. In some embodiments, the execution module 102C may be configured to generate new data from execution of the query.

In some embodiments, the execution module 102C may be configured to execute at least a portion of a query without scanning any data. The execution module 102C may be configured to execute at least the portion of the query by reading predetermined metadata (e.g., statistics) stored in the partition index. The execution module 102C may be configured to read the metadata without accessing a data partition.

The partition index 104 and the data partitions 106 are described herein with reference to FIG. 2B.

FIG. 3B shows a diagram illustrating components of the ingestion engine 108, according to some embodiments of the technology described herein. As shown in FIG. 3B, the ingestion engine 108 includes a communication module 108A, a data partitioner module 108B and an index generator module 108C.

The communication module 108A may be configured to communicate with one or more data sources for ingesting data. As described herein with reference to FIG. 2B, the communication module 108A may be configured to obtain data on a schedule. In some embodiments, the communication module 108A may be configured to obtain data in response to a command (e.g., a software application or user command). In some embodiments, the communication module 108A may be configured to communicate with a data source through a communication network. For example, the communication module 108A may communicate with cloud based database systems through the Internet.

The data partitioner module 108B may be configured to divide data among the data partitions 106. In some embodiments, the data partitioner module 108B may be configured to determine the data partitions according to expected use of the data (e.g., as indicated by a user of the data lake 100). Example techniques of how the data partitioner module 108B may be configured to generate the data partitions 106 are described herein with reference to FIG. 2B. In some embodiments, the data partitioner 108B may be configured to update the data partitions 106 as data is ingested. For example, the data partitioner 108B may add data to existing data partitions. In another example, the data partitioner 108B may generate additional data partitions.

In some embodiments, the data partitioner 108B may be configured to perform rebalancing of data. The rebalancing may maintain performance (e.g., of query execution) as the quantity of data in a data lake grows. In some embodiments, the data partitioner 108B may be configured to rebalance data by maintaining a distribution of data among the data partitions 106. For example, the data partitioner 108B may move data from data partition to another data partition when the data partitioner 108B determines that the data partitions have reached a threshold level of imbalance (e.g., difference in amount of data stored). In some embodiments, the data partitioner 108B may be configured to balance data partitions among multiple shards. For example, the data partitioner 108B may be configured to maintain a target distribution of data partitions among the shards.

In some embodiments, the data partitioner 108B may be configured to rebalance data by consolidating multiple records. For example, the data partitioner 108B may consolidate multiple files into a single file. As an illustrative example, the data partitioner 108B may target storing files of a particular size (e.g., 10 MB, 100 MB, 200 MB, 500 MB, 1 GB, 1.5 GB, 2 GB, 50 GB, 100 GB, or other suitable size). The data partitioner 108B may consolidate multiple files that are less than the particular size. For example, the data partitioner 108B may consolidate millions of 1 MB files into a smaller number of 100 MB files. In some embodiments, the data partitioner 108B may be configured to perform rebalancing at regular time periods. In some embodiments, the data partitioner 108B may be configured to perform rebalancing in response to a command (e.g., a user command or a software application command).

The index generator module 108C may be configured to generate the partition index 104. The index generator module 108C may be configured to generate the partition index 104 as described herein with reference to FIG. 2B. In some embodiments, the index generator module 108C may be configured to organize the partition index 104 according to a key. The index generator module 108C may be configured to generate entries in the partition index 104 corresponding to data partitions. The data partitions may be associated with respective key values (e.g., ranges and/or sets of unique values). The partition index 104 may thus be navigated using a key value (e.g., indicated by a query).

In some embodiments, the index generator module 108C may be configured to update the partition index 104. For example, the index generator module 108C may update entries of the partition index 104 transactionally. In some embodiments, the index generator 108C may be configured to update the partition index 104 as data is ingested into the data lake 100. In some embodiments, the index generator module 108C may be configured to update the partition index 104 in response to changes in the data partitions (e.g., due to rebalancing, addition or new data partitions, consolidation of data partitions, and/or other changes).

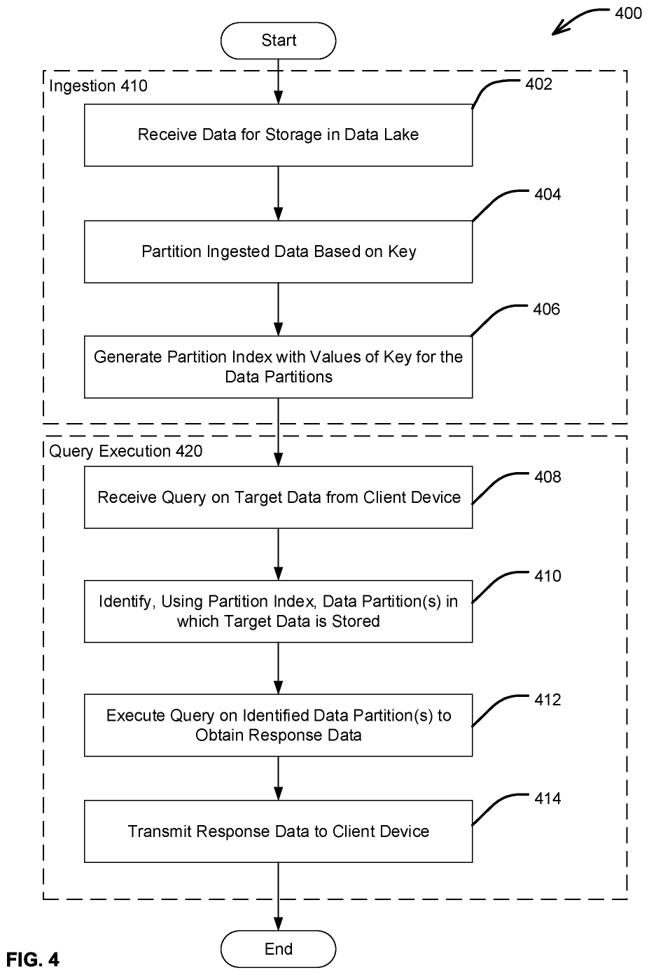

FIG. 4 shows a flowchart of an example process 400 for optimizing queries in a data lake, according to some embodiments of the technology described herein. Process 400 may be performed by the query system 130 described herein with reference to FIGS. 2A-2B. For example, the process 400 may be performed to optimize queries performed in the data lake 100.

Process 400 includes an ingestion portion 410 comprising of blocks 402-406 and a query execution portion 420 comprising of blocks 408-414. Although the portions 410, 420 are included as a single process, in some embodiments, they may be executed independently. In some embodiments, the ingestion 410 and query performance 420 may be performed sequentially. In some embodiments, the ingestion 410 and query performance 420 may be performed concurrently. In some embodiments, the ingestion 410 and the query performance 420 may be performed by separate systems (e.g., separate computer systems).

Process 400 begins at block 402, where the system performing process 400 ingests data for storage in a data lake (e.g., data lake 100). In some embodiments, the system may be configured to ingest data records (e.g., files, documents, and/or other types of data records). The system may be configured to ingest the data from one or multiple data lake sources. In some embodiments, the system may be configured to ingest data at regular time periods. For example, the system may ingest data as part of a backup or archiving schedule. Example time periods are described herein. In some embodiments, the system may be configured to receive data through a communication network (e.g., the Internet) from multiple different cloud database sources.

Next, process 400 proceeds to block 404, where the system partitions ingested data into multiple data partitions based on a key. In some embodiments, the system may be configured to divide the data into multiple data partitions according to expected use of data stored in the data lake. For example, the system may divide the data into data partitions based on one or more fields that are to be frequently queried. In this example, the system may divide ingested data into data partitions based on the field(s). The system may use the field(s) as the key. In some embodiments, the data partitions may be stored in shards that are associated with respective ranges of a shard key. The system may be configured to partition the data into the multiple partitions based on the shard key.

In some embodiments, the system may be configured to receive user input indicating one or more fields of the data to use as a key. For example, the system may receive a configuration file indicating the field(s) to be used as the key. In some embodiments, the system may be configured to determine the key by identifying one or more fields expected to be frequently queried. The system may use the identified field(s) as the key. For example, the system may analyze a set of previously executed queries to identify field(s) that are most frequently queried and use the identified field(s) as the key. In some embodiments, the system may be configured to determine a particular ordering of multiple fields that form a key. For example, the ordering may be based on frequency of field being queried. Thus, the most frequently queried field would be the first field in the key, and the least queried field would be the last field in the key. In some embodiments, the system may receive user input indicating the ordering of the keys. In some embodiments, the system may determine the ordering of the keys. For example, the system may analyze a set of previously executed keys to determine frequency at which fields are queries, and determine the ordering based on the frequencies.

In some embodiments, the system may be configured to determine data partitions to optimize performance of queries. For example, the system may maintain data partition sizes that meet a threshold level of performance. In some embodiments, the system may be configured to maintain data partitions of a target size (e.g., approximately 100 MB). For example, the system may be configured to consolidate multiple data partitions into a single data partition that is approximately of the target size. In embodiments in which the data partitions are stored among shards, the system may be configured to balance the data partitions among the shards. For example, the system may target a uniform distribution of data partitions among shards. In some embodiments, the system may be configured to distribute data partitions among multiple shards obtained by dividing a single shard.

In some embodiments, the system may be configured to store the data in one or more storage formats. Example storage formats are described herein. In some embodiments, the system may be configured to select format(s) to optimize performance of queries. For example, the system may select a columnar format when more aggregation queries are to be performed on the data. In some implementations, the columnar format may optimize for flat or nested data. In another example, the system may select a row oriented format when specific records are more likely to be queried for. In some embodiments, the system may be configured to use different storage formats for different portions of data to optimize queries on each portion of data.

Next, process 400 proceeds to block 406, where the system generates a partition index for the data partitions. The partition index may be a catalog that can be used for executing queries to identify a data partition in which data targeted by a query is located. The catalog may include entries corresponding to respective data partitions and associated key values. In some embodiments, the system may be configured to include, in each entry, index information for a data partition. For example, the entry may indicate a list of unique key values stored in the data partition. In another example, the entry may indicate a range of key values stored in the data partition. In another example, the entry may indicate a minimum and maximum key value stored in the data partition.

In some embodiments, the system may be configured to determine additional metadata about data stored in data partitions and store the metadata in the partition index. For example, the system may determine statistics (e.g., counts, sums, means, variances, etc.) for data in data partitions. The predetermined metadata may be stored. In some cases, the metadata may eliminate a need to scan the data partition for any data because it has been previously determined and stored during ingestion. In some embodiments, the system may be configured to determine and store, in the partition index, metadata for each data partition. In some embodiments, the system may be configured to determine and store, in the partition index, metadata for different sets of one or more data partitions.

Next, process 400 proceeds to block 408, where the system receives a query on target data from a client device. The system may be configured to receive a query through a user interface, a command line, a script, a software application command, and/or other source. In some embodiments, the system may be configured to receive the query through an application program interface (API). In some embodiments, the system may be configured to receive the query through a communication network (e.g., the Internet).

Next, process 400 proceeds to block 410, where the system identifies, using the partition index, one or more data partition(s) in which target data is stored. For example, the system may search the partition index for one or more entries indicating data partition(s) that include the target data. For example, the one or more entries may indicate that records with key value(s) indicated by the query are stored in the data partition(s). In another example, the system may search the partition index for key value(s) to identify data partition(s) associated with entries including the field value(s). The system may be configured to search the partition index without having to scan stored data for the stored data.

It should be appreciated that in some cases, the system may not identify any data partitions in which data targeted by the query is stored. In some embodiments, the system may be configured to not execute a query when zero data partitions are identified. For example, the system may transmit a message to a user indicating that the target data was not found. In some embodiments, the system may be configured to execute the query by using a federated query. The system may be configured to transmit the query to a storage management system (e.g., of a data store associated with a virtual collection to which the target data belongs) that manages storage of the target data for execution of the query. The system may obtain response data obtained from execution of the query by the storage management system from the storage management system.

Next, process 400 proceeds to block 412 where the system executes the query on the identified data partition(s) to obtain response data. For example, the system may locate the data partition(s) in a data store, and then execute the query on the data partition(s). The system may be configured to execute a query by reading, writing, updating, deleting, generating new data using the target data, and/or performing another operation using the target data. The system may be configured to obtain response data (e.g., read data, updated data, a confirmation, new data and/or other response data) from execution of the query.

Next, process 400 proceeds to block 414, where the system transmits the response data to the client device. For example, the system may be configured to transmit the response data for display in a user interface of the client device. In another example, the system may transmit a file including the response data to the client device.

FIG. 5 shows an example graphical user interface (GUI) 500 for creating a data lake ingestion pipeline, according to some embodiments of the technology described herein. The GUI 500 allows a user to indicate a data source, and a namespace. In the example of FIG. the GUI 500 includes fields 502, 504, 506 that allow a user to indicate a data source by specifying a cluster, database, and collection. The GUI 500 further includes a field 508 in which a user may specify a name of the data set storing data ingested through the pipeline. The GUI 500 further includes a GUI element 510 that allows a user to select a region in which ingested data is to reside. In the example of FIG. 5, the GUI element 510 is a pull-down menu providing a predetermined set of regions from which a user may select from for storage of data at the region.

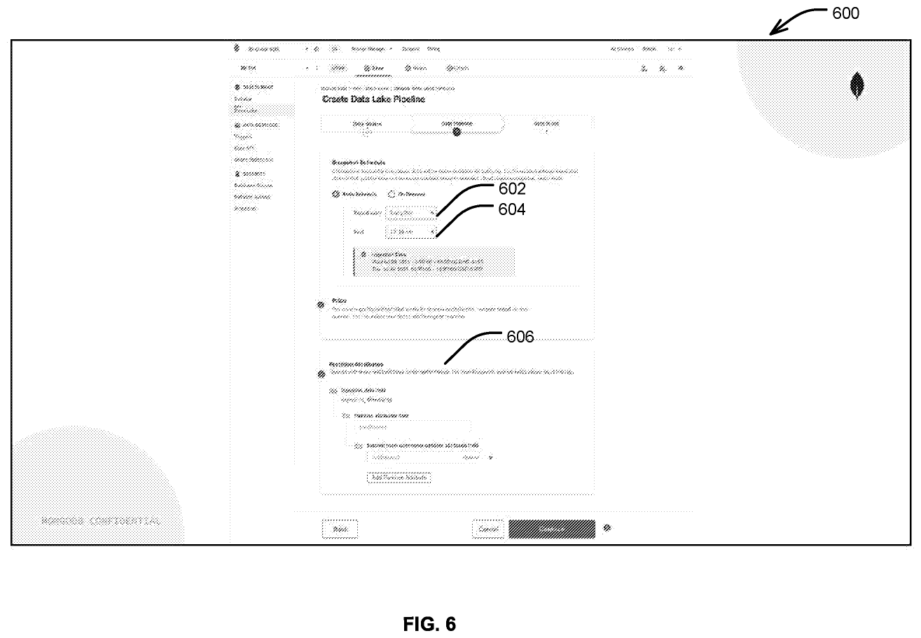

FIG. 6 shows an example GUI 600 that allows a user to specify a schedule for data ingestion, according to some embodiments of the technology described herein. The GUI 600 provides a time period based schedule in which data is ingested at regular time periods. For example, the GUI 600 provides GUI element 602 that allows a user to specify a frequency (e.g., every day, every week, every month, etc.) at which to ingest data and a GUI element 604 specifying a time of ingestion. The GUI 600 also provides a demand based schedule in which data is ingested based on demand (e.g., threshold amount of data to be ingested is reached). As shown in FIG. 6, the GUI 600 includes a GUI element 606 that allows a user to indicate data field(s) to be ingested, and data field(s) to be used for data partitioning. The field(s) to be used for data partitioning may be used as keys with which to partition ingested data (e.g., as described herein with reference to FIG. 4). In some embodiments, the system may be configured to automatically determine fields to be used for data partitioning.

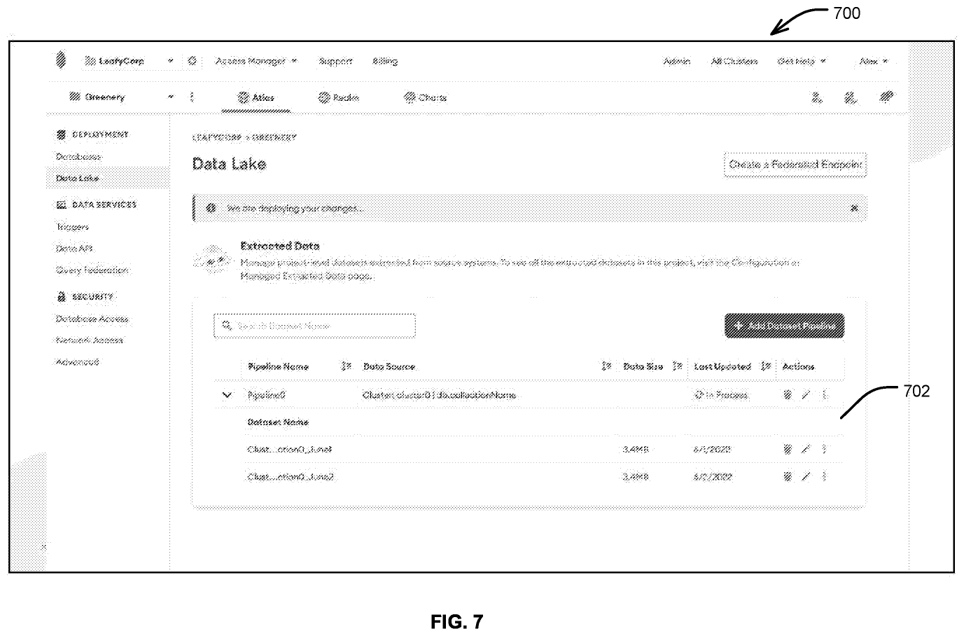

FIG. 7 shows an example GUI 700 that indicates data ingested through the data lake ingestion pipeline, according to some embodiments of the technology described herein. As shown in FIG. 7, the GUI portion 702 indicates datasets storing data ingested through configured pipelines.

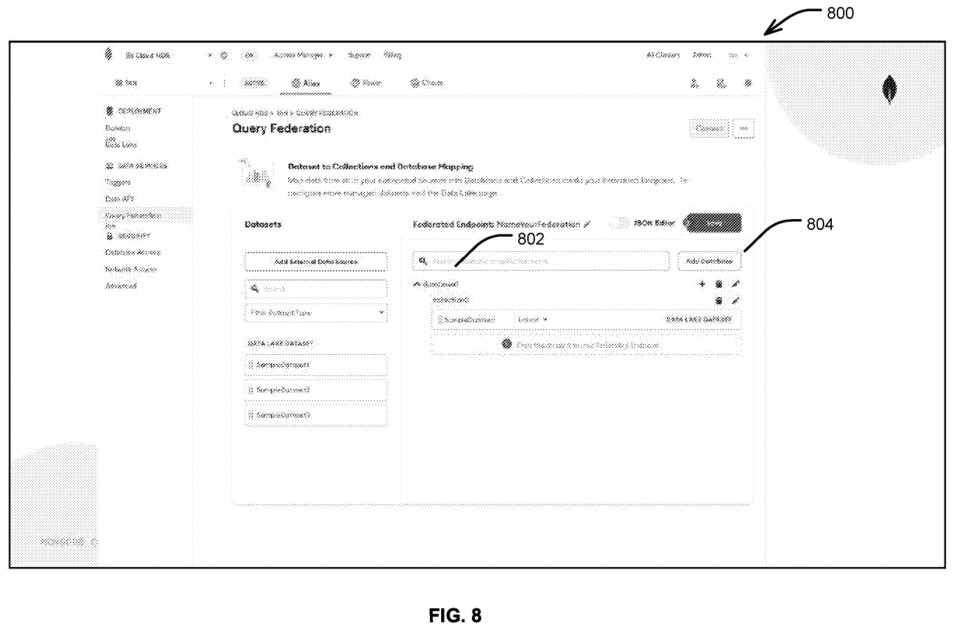

FIG. 8 shows an example GUI 800 that allows a user to set up ingested data as a source in a virtual collection of data, according to some embodiments of the technology described herein. A user may select an ingested data lake dataset and include it in a virtual database (e.g., including one or more virtual collections). The data lake dataset storing ingested data may be mapped through the GUI 800 to the virtual database and/or to collection(s) thereof. The GUI 800 includes a search field 802 through which a user may search for existing databases. The GUI 800 includes a selectable element 804 that allows a user to create a new database to which a data lake dataset may be mapped. The user may further perform queries on the database.

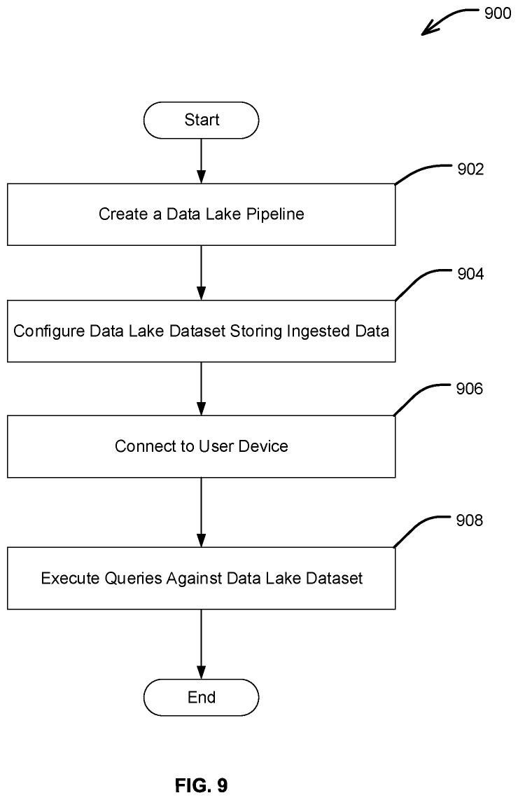

FIG. 9 shows an example process 900 of implementing a data lake query system, according to some embodiments of the technology described herein. In some embodiments, process 900 may be performed by the query system 130 and/or the ingestion engine 108 described herein with reference to FIGS. 2A-3B.

Process 900 begins at block 902, where the system creates a data lake pipeline to ingest data from a data lake. In some embodiments, the system may be configured to create the data lake pipeline based on user input received through a GUI. The system may provide a GUI through which a user may select the data lake data from a set of one or more database deployments. For example, the system may be configured to receive, through the GUI, input indicating a cluster storing data lake data, a database within the cluster, and/or a collection within the database. In some embodiments, the system may be configured to determine an identifier for the pipeline. For example, the system may receive, through a GUI, user input specifying a name for the pipeline. As another example, the system may automatically generate an identifier for the pipeline.

In some embodiments, the system may be configured to determine an ingestion schedule for the pipeline. The system may be configured to determine a frequency at which to extract data from the data lake. For example, the system may determine an ingestion schedule in which the system extracts data from the data lake every 12 hours, every day, every week, every month, semi-annually, annually, or other suitable frequency. In some embodiments, the system may be configured to determine an ingestion schedule based on a backup schedule of the data lake. For example, the system may determine an ingestion schedule with an extraction frequency that matches a backup frequency of the data.

In some embodiments, the system may be configured to determine one or more geographic regions in which to store data ingested through the pipeline. For example, the system may select the region(s) from a predetermined set of available geographic regions in which data can be stored. To illustrate, the geographic regions may be a set of cities, states, countries, and/or other type of geographic region. In some embodiments, the system may be configured to automatically select a geographic region that is closest to the data lake. In some embodiments, the system may be configured to determine the geographic region(s) in which to store ingested data based on user input (e.g., received through a GUI).

In some embodiments, the system may be configured to determine a set of one or more fields in ingested data according to which the system partitions ingested data (e.g., as described herein at block 404 of process 400 described herein with reference to FIG. 4). For example, the system may identify a set of one or more most frequently queried fields in the data lake data. In some embodiments, the field(s) may be nested field(s) (e.g., specified using a dot notation). In some embodiments, the field(s) may be inside an array. In some embodiments, the system may be configured to determine an order of the set of field(s) for use in querying. Data may be optimized for queries based on an order of the set of field(s). For example, data may be optimized for queries for a first field, followed by a second field. To illustrate, the system may determine to optimize query performance using a primary year field and a secondary title field.

In some embodiments, the system may be configured to exclude one or more fields from being extracted (e.g., to refrain from ingesting unnecessary data). For example, the system may provide a GUI through which a user can provide input indicating one or more fields that are excluded from ingestion. As another example, the system may automatically determine field(s).

In some embodiments, the system may be configured to generate the pipeline using an application program interface (API). For example, the system may transmit a command using the API that triggers generation of the API. The command may indicate, for example, a name of the pipeline, an ingestion destination of the pipeline (e.g., a sink), an ingestion source of the pipeline, and/or one or more fields to be excluded for the pipeline. An example such command is illustrated below:

```
{
  ″name″: ″string″,
  ″sink″: {
      ″type″: ″DLS″
    },
  ″source″: {
      ″type″: ″PERIODIC_CPS″,
      ″clusterName″: ″string″,
      ″collectionName″: ″string″,
      ″databaseName″: ″string″
    },
  ″transformations″: [
      {
        “field”: “string,”
        “type”: “EXCLUDE”
      }
    ]
}
```

In the above illustrative example, the command creates a pipeline named “string”, for data to be ingested from a source designated by the “source” parameter in the above API command. Fields to be excluded from ingestion are indicated by the “transformations” parameter. The ingested data is stored in the destination designated by the “sink” parameter in the above command.

After creating a data lake pipeline. Process 900 proceeds to block 904, where the system configures a data lake dataset for storing data ingested through the pipeline. In some embodiments, the system may create one or more virtual databases, collections, and/or views that map to the data lake dataset. A database may include one or more collections, each storing a set of data records called documents. A view may be a read-only queryable object. In some embodiments, the system may create a database instance with the virtual database(s), collection(s), and/or view(s) mapped to the data lake dataset. The system may allow a user to create the database instance through a GUI and/or using a configuration file (e.g., a JSON file) specifying a configuration of the database instance. The user may define the virtual database(s), collection(s), and/or view(s) through the GUI and/or in the configuration file. The system may be configured to map the data lake dataset to the virtual database(s), collection(s), and/or view(s). For example, the system may allow a user to associate the pipeline with the database(s), collection(s), and/or view(s) through a GUI. As another example, a configuration file may associate the pipeline with the database(s), collection(s), and/or view(s).

In some embodiments, the system may be configured to ingest data for storage in the configured data lake dataset, partition ingested data based on key (e.g., one or more fields), and generate a partition index with values of the key for the data partitions. For example, the system may perform ingestion 410 of process 400 described herein with reference to FIG. 4.

Next, process 900 proceeds to block 906, where the system connects a user device to the configured data lake dataset. In some embodiments, the system may provide a GUI though which a user may select a database instance (e.g., created at block 904) to request a connection. In some embodiments, the system may create a connection using a connection string. For example, the user device may access a connection string and request a connection (e.g., through a shell, driver, or software application) with the connection string. In some embodiments, the system may authenticate the user (e.g., by requiring a password).

Next, process 900 proceeds to block 908, where the system executes queries against the data lake dataset. For example, the system may receive queries submitted from a user device through a terminal. As another example, the system may receive queries submitted from a user device through a GUI. The system may be configured to execute a query by performing query execution 420 of process 400 described herein with reference to FIG. 4.

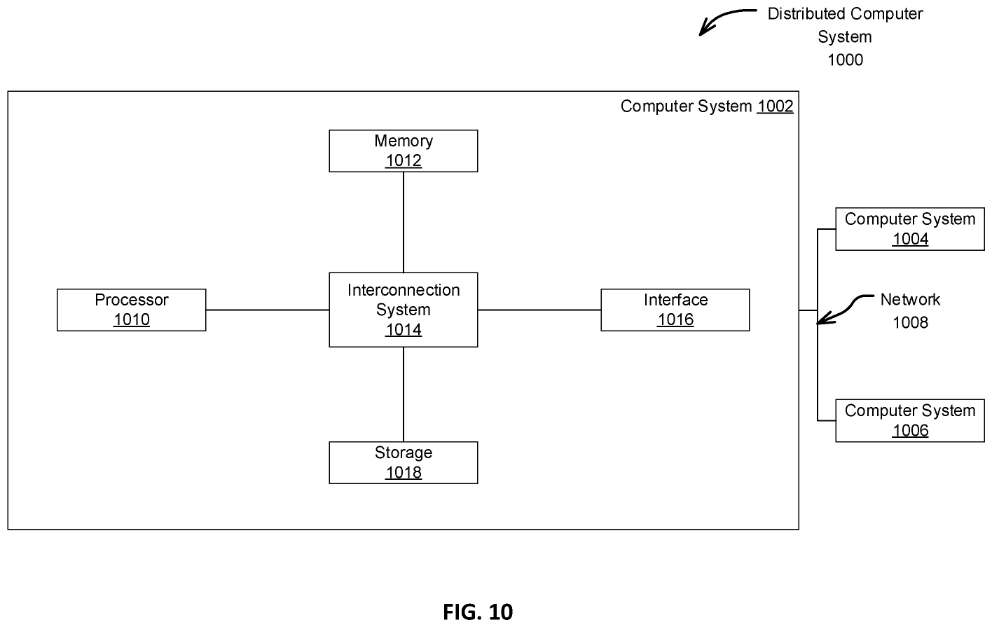

FIG. 10, shows a block diagram of a specially configured distributed computer system 1000, in which some embodiments of the technology described herein can be implemented. As shown, the distributed computer system 1000 includes one or more computer systems that exchange information. More specifically, the distributed computer system 1000 includes computer systems 1002, 1004, and 1006. As shown, the computer systems 1002, 1004, and 1006 are interconnected by, and may exchange data through, a communication network 1008. The network 1008 may include any communication network through which computer systems may exchange data. To exchange data using the network 1008, the computer systems 1002, 1004, and 1006 and the network 1008 may use various methods, protocols, and standards, including, among others, Fiber Channel, Token Ring, Ethernet, Wireless Ethernet, Bluetooth, IP, IPV6, TCP/IP, UDP, DTN, HTTP, FTP, SNMP, SMS, MMS, SS10, JSON, SOAP, CORBA, REST, and Web Services. To ensure data transfer is secure, the computer systems 1002, 1004, and 1006 may transmit data via the network 1008 using a variety of security measures including, for example, SSL or VPN technologies. While the distributed computer system 1000 illustrates three networked computer systems, the distributed computer system 1000 is not so limited and may include any number of computer systems and computing devices, networked using any medium and communication protocol.

As illustrated in FIG. 10, the computer system 1002 includes a processor 1010, a memory 1012, an interconnection element 1014, an interface 1016 and data storage element 1018. To implement at least some of the aspects, functions, and processes disclosed herein, the processor 1010 performs a series of instructions that result in manipulated data. The processor 1010 may be any type of processor, multiprocessor, or controller. Example processors may include a commercially available processor such as an Intel Xeon, Itanium, Core, Celeron, or Pentium processor; an AMD Opteron processor; an Apple A10 or A5 processor; a Sun UltraSPARC processor; an IBM Power5+ processor; an IBM mainframe chip; or a quantum computer. The processor 1010 is connected to other system components, including one or more memory devices 1012, by the interconnection element 1014.

The memory 1012 stores programs (e.g., sequences of instructions coded to be executable by the processor 1010) and data during operation of the computer system 1002. Thus, the memory 1012 may be a relatively high performance, volatile, random access memory such as a dynamic random access memory (“DRAM”) or static memory (“SRAM”). However, the memory 1012 may include any device for storing data, such as a disk drive or other nonvolatile storage device. Various examples may organize the memory 1012 into particularized and, in some cases, unique structures to perform the functions disclosed herein. These data structures may be sized and organized to store values for particular data and types of data.

Components of the computer system 1002 are coupled by an interconnection element such as the interconnection mechanism 1014. The interconnection element 1014 may include any communication coupling between system components such as one or more physical busses in conformance with specialized or standard computing bus technologies such as IDE, SCSI, PCI, and InfiniBand. The interconnection element 1014 enables communications, including instructions and data, to be exchanged between system components of the computer system 1002.

The computer system 1002 also includes one or more interface devices 1016 such as input devices, output devices and combination input/output devices. Interface devices may receive input or provide output. More particularly, output devices may render information for external presentation. Input devices may accept information from external sources. Examples of interface devices include keyboards, mouse devices, trackballs, microphones, touch screens, printing devices, display screens, speakers, network interface cards, etc. Interface devices allow the computer system 1002 to exchange information and to communicate with external entities, such as users and other systems.

The data storage element 1018 includes a computer readable and writeable nonvolatile, or non-transitory, data storage medium in which instructions are stored that define a program or other object that is executed by the processor 1010. The data storage element 1018 also may include information that is recorded, on or in, the medium, and that is processed by the processor 1010 during execution of the program. More specifically, the information may be stored in one or more data structures specifically configured to conserve storage space or increase data exchange performance. The instructions may be persistently stored as encoded signals, and the instructions may cause the processor 1010 to perform any of the functions described herein. The medium may, for example, be optical disk, magnetic disk, or flash memory, among others. In operation, the processor 1010 or some other controller causes data to be read from the nonvolatile recording medium into another memory, such as the memory 1012, that allows for faster access to the information by the processor 1010 than does the storage medium included in the data storage element 1018. The memory may be located in the data storage element 1018 or in the memory 1012, however, the processor 1010 manipulates the data within the memory, and then copies the data to the storage medium associated with the data storage element 1018 after processing is completed. A variety of components may manage data movement between the storage medium and other memory elements and examples are not limited to particular data management components. Further, examples are not limited to a particular memory system or data storage system.

Although the computer system 1002 is shown by way of example as one type of computer system upon which various aspects and functions may be practiced, aspects and functions are not limited to being implemented on the computer system 1002 as shown in FIG. Various aspects and functions may be practiced on one or more computers having different architectures or components than that shown in FIG. 10. For instance, the computer system 1002 may include specially programmed, special-purpose hardware, such as an application-specific integrated circuit (“ASIC”) tailored to perform a particular operation disclosed herein. While another example may perform the same function using a grid of several general-purpose computing devices running MAC OS System X with Motorola PowerPC processors and several specialized computing devices running proprietary hardware and operating systems.

The computer system 1002 may be a computer system including an operating system that manages at least a portion of the hardware elements included in the computer system 1002. In some examples, a processor or controller, such as the processor 1010, executes an operating system. Examples of a particular operating system that may be executed include a Windows-based operating system, such as, Windows 10 or 11 operating systems, available from the Microsoft Corporation, a MAC OS System X operating system or an iOS operating system available from Apple Computer, one of many Linux-based operating system distributions, for example, the Enterprise Linux operating system available from Red Hat Inc., a Solaris operating system available from Oracle Corporation, or a UNIX operating systems available from various sources. Many other operating systems may be used, and examples are not limited to any particular operating system.

The processor 1010 and operating system together define a computer platform for which application programs in high-level programming languages are written. These component applications may be executable, intermediate, bytecode or interpreted code which communicates over a communication network, for example, the Internet, using a communication protocol, for example, TCP/IP. Similarly, aspects may be implemented using an object-oriented programming language, such as .Net, Java, C++, C# (C-Sharp), Python, or JavaScript. Other object-oriented programming languages may also be used. Alternatively, functional, scripting, or logical programming languages may be used.

Additionally, various aspects and functions may be implemented in a non-programmed environment. For example, documents created in HTML, XML, or other formats, when viewed in a window of a browser program, can render aspects of a graphical-user interface, or perform other functions. Further, various examples may be implemented as programmed or non-programmed elements, or any combination thereof. For example, a web page may be implemented using HTML while a data object called from within the web page may be written in C++. Thus, the examples are not limited to a specific programming language and any suitable programming language could be used. Accordingly, the functional components disclosed herein may include a wide variety of elements (e.g., specialized hardware, executable code, data structures or objects) that are configured to perform the functions described herein.

In some examples, the components disclosed herein may read parameters that affect the functions performed by the components. These parameters may be physically stored in any form of suitable memory including volatile memory (such as RAM) or nonvolatile memory (such as a magnetic hard drive). In addition, the parameters may be logically stored in a proprietary data structure (such as a database or file defined by a user space application) or in a commonly shared data structure (such as an application registry that is defined by an operating system). In addition, some examples provide for both system and user interfaces that allow external entities to modify the parameters and thereby configure the behavior of the components.

Having thus described several aspects of at least one embodiment of the technology described herein, it is to be appreciated that various alterations, modifications, and improvements will readily occur to those skilled in the art.

Such alterations, modifications, and improvements are intended to be part of this disclosure, and are intended to be within the spirit and scope of disclosure. Further, though advantages of the technology described herein are indicated, it should be appreciated that not every embodiment of the technology described herein will include every described advantage. Some embodiments may not implement any features described as advantageous herein and in some instances one or more of the described features may be implemented to achieve further embodiments. Accordingly, the foregoing description and drawings are by way of example only.

The above-described embodiments of the technology described herein can be implemented in any of numerous ways. For example, the embodiments may be implemented using hardware, software, or a combination thereof. When implemented in software, the software code can be executed on any suitable processor or collection of processors, whether provided in a single computer or distributed among multiple computers. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semicustom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. However, a processor may be implemented using circuitry in any suitable format.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, aspects of the technology described herein may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments described above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computers or other processors to implement various aspects of the technology as described above. As used herein, the term “computer-readable storage medium” encompasses only a non-transitory computer-readable medium that can be considered to be a manufacture (i.e., article of manufacture) or a machine. Alternatively, or additionally, aspects of the technology described herein may be embodied as a computer readable medium other than a computer-readable storage medium, such as a propagating signal.

The terms “program” or “software” are used herein in a generic sense to refer to any type of computer code or set of computer-executable instructions that can be employed to program a computer or other processor to implement various aspects of the technology as described above. Additionally, it should be appreciated that according to one aspect of this embodiment, one or more computer programs that when executed perform methods of the technology described herein need not reside on a single computer or processor, but may be distributed in a modular fashion amongst a number of different computers or processors to implement various aspects of the technology described herein.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the technology described herein may be used alone, in combination, or in a variety of arrangements not specifically described in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the technology described herein may be embodied as a method, of which examples are provided herein including with reference to FIGS. 3 and 7. The acts performed as part of any of the methods may be ordered in any suitable way. Accordingly, embodiments may be constructed in which acts are performed in an order different than illustrated, which may include performing some acts simultaneously, even though shown as sequential acts in illustrative embodiments.

Further, some actions are described as taken by an “actor” or a “user.” It should be appreciated that an “actor” or a “user” need not be a single individual, and that in some embodiments, actions attributable to an “actor” or a “user” may be performed by a team of individuals and/or an individual in combination with computer-assisted tools or other mechanisms.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A system for optimizing queries in a data lake storing data originating from one or more data lake sources, the system comprising:
memory configured to store:
data objects of different native formats originating from the one or more data lake sources;
a plurality of data partitions storing data from the data objects originating from the one or more data lake sources and partitioned based on a key; and
a partition index comprising entries of values of the key associated with respective data partitions of the plurality of data partitions; and
a processor configured to:
receive, through a communication network, from a client device, a query on target data;
identify, using the partition index, at least one data partition of the plurality of data partitions in which the target data is stored;
execute the query on the identified at least one data partition to obtain response data; and
transmit, through the communication network, to the client device, the response data.

2. The system of claim 1, wherein the plurality of data partitions are stored in a plurality of shards associated with respective ranges of a shard key.

3. The system of claim 2, wherein the key based on which the plurality of data partitions are partitioned is the shard key.

4. The system of claim 2, wherein the processor is configured to perform rebalancing of the plurality of data partitions among the plurality of shards.

5. The system of claim 1, wherein the processor is configured to identify, using the partition index, the at least one data partition in which the target data is stored by performing:
identify at least one value of the key included in the query; and
identify the at least one partition in the partition index based on the at least one value of the key included in the query.

6. The system of claim 1, wherein the processor is configured to:
receive, through the communication network from the one or more data lake sources, one or more data objects to be stored in the data lake; and
store data from the one or more data objects in at least one data partition of the plurality of data partitions.

7. The system of claim 6, wherein the processor is configured to:
sort the data from the one or more data objects into the at least one data partition using one or more values of the key in the data.

8. The system of claim 1, wherein the processor is configured to partition the data from the plurality of data objects into the plurality of data partitions.

9. The system of claim 8, wherein the processor is configured to partition the data into the plurality of data partitions by performing:
determine the key; and
partition the data from the data objects originating from the one or more data lake sources based on the key.

10. The system of claim 9, wherein the processor is configured to determine the key by performing:
receive user input indicating one or more fields of the data to be used as the key.

11. The system of claim 9, wherein the processor is configured to determine the key by performing:
determine at least one field in the data expected to be used in queries received by the system; and
use the at least one field as the key.

12. The system of claim 1, wherein the processor is configured to group, in the memory, data from at least some of the plurality of data objects that share a native format.

13. The system of claim 1, wherein one or more of the plurality of data partitions comprise a plurality of files, and the processor is further configured to:
determine that the files contain less than a threshold amount of data; and
combine the plurality of files into a single file.

14. The system of claim 13, wherein the threshold amount of data is 100 megabytes (MB).

15. The system of claim 1, wherein the plurality of data partitions are configured to store at least some of the data in a columnar storage format.

16. The system of claim 15, wherein the columnar storage format is APACHE PARQUET.

17. The system of claim 1, wherein the processor is configured to:
receive, from the communication network, from the client device, a query for metadata about a set of data, the metadata stored in the partition index;
execute the query by reading the metadata from the partition index without accessing a data partition of the plurality of data partitions; and
transmit, through the communication network, to the client device, the metadata.

18. The system of claim 1, wherein:
at least some of the data objects are stored in respective virtual collections; and
the processor is further configured to:
receive, through the communication network, from the client device, a second query on second target data in a first virtual collection;
transmit, through the communication network, to a data storage system associated with the first virtual collection, information indicating the second query;
receive, through the communication network, from the data storage system, second response data obtained from executing the second query; and
transmit, through the communication network, to the client device, the second response data.

19. A method of optimizing queries in a data lake storing data from different data lake sources, the method comprising:
using a processor to perform:
storing, in memory:
data objects of different native formats originating from the one or more data lake sources;
a plurality of data partitions storing data from the data objects and partitioned based on a key; and
a partition index comprising entries of values of the key associated with respective data partitions of the plurality of data partitions; and
receiving, through a communication network, from a client device, a query on target data;
identifying, using the partition index, at least one data partition of the plurality of data partitions in which the target data is stored;
executing the query in the identified at least one data partition to obtain response data; and
transmitting, through the communication network, to the client device, the response data.

20. The method of claim 19, further comprising storing the plurality of data partitions in a plurality of shards associated with respective ranges of a shard key.

21. The method of claim 20, wherein the key based on which the plurality of data partitions are partitioned is the shard key.

22. The method of claim 19, wherein identifying, using the partition index, the at least one data partition in which the target data is stored by performing:
identifying at least one value of the key included in the query; and
identifying the at least one partition in the partition index based on the at least one value of the key included in the query.
